(19) United States
(12) Patent Application Publication
(10) Pub. No.: US 2023/0377397 A1
(43) Pub. Date: Nov. 23, 2023

(54) Entry/Exit Management System and Entry/Exit Management Method

(71) Applicant: Hitachi, Ltd., Chiyoda-ku, Tokyo (JP)

(72) Inventors: Koki OGAWA, Chiyoda-ku, Tokyo (JP); Kenji OTSUKA, Chiyoda-ku, Tokyo (JP); Atsufumi KIYOKUNI, Chiyoda-ku, Tokyo (JP); Masayuki AKATSU, Chiyoda-ku, Tokyo (JP)

(21) Appl. No.: 18/027,507

(22) PCT Filed: Dec. 23, 2020
(86) PCT No.: PCT/JP2020/048084

§ 371 Date: Mar. 21, 2023

(51) Int. Cl. G07C 9/27; G07C 9/22

(52) U.S. Cl. CPC G07C 9/27; G07C 9/22; G07C 2209/08

(57) ABSTRACT

When there is a request for issuing a two-dimensional code from an entering person terminal, it is determined whether a person who has made the request for issuing is an employee, and it is inquired whether the employee who has made the request for issuing of the two-dimensional code is an employee registered in an employee database. In response to this inquiry, in a case where the employee who has made the request for issuing the two-dimensional code is a registered employee and has a right to enter a facility, a two-dimensional code containing time limit information with an expiration date for entry is issued. However, in a case where the employee who has made the request for issuing the two-dimensional code is not a registered employee and does not have the right to enter the facility, an error code is sent to the entering person terminal. Note that the request for issuing the two-dimensional code from the entering person terminal to a reception server is made when the employee enters a predetermined range of the facility to enter and the employee does not have a valid two-dimensional code.

### TECHNICAL FIELD

The present invention relates to an entry/exit management system and an entry/exit management method.

### BACKGROUND ART

In recent years, entry/exit management systems installed in offices, commercial buildings, facilities for events, etc. have been capable of achieving a high level of security due to development of information and communication technology and dramatic improvement in performance of electronic devices. This is because various information communication technology and utilization of a large number of electronic devices have been widely spread.

For example, in an entry/exit management system that operates on a worker platform that performs identification (ID) management, a system that determines whether to permit entry using a quick response (QR) code (registered trademark, the same applies hereinafter) has been achieved. In other words, when a QR code is displayed on a worker or visitor's smartphone and presented at a gate at an entrance, the QR code is read. Then, the gate is opened only when the system determines that entry is possible.

Although a QR code is a convenient medium in such an entry/exit management system, a QR code itself has a problem that the QR code is easily copied. For this reason, it is also adopted to create an application that prohibits acquisition of a screenshot of a QR code, but it cannot be prevented that a QR code displayed on another smartphone is directly captured and abused.

Patent Literature 1 describes an access control system that maintains security without using an access card.

A technique described in Patent Literature 1 captures an image of a user standing in front of a door of a room with a monitoring camera, analyzes the captured image, and registers an extracted image of the user in a database. Then, a QR code including a door ID and a user ID registered together with the captured image is generated and sent to a terminal held by the user. As a result, in the access control system, the user effectively uses the terminal carried by the user, so that security is maintained without using an access card.

### CITATION LIST

### Patent Literature

Patent Literature 1: JP 2020-042374 A

### SUMMARY OF INVENTION

### Technical Problem

However, face authentication adopted in the access control system described in Patent Literature 1 has a problem that it is difficult to perform an accurate determination in a short period of time due to the influence of brightness/darkness of a photographing environment, glasses, a mask, and a hat of the user, and the like. In other words, in order to perform an accurate determination, it is necessary to install a camera having a high resolution at an appropriate position, capture an image of the user, and use a determination device having high processing performance.

An object of the present invention is to provide an entry/exit management system and an entry/exit management method that maintain security by shortening a period during which a QR code can be imaged by giving time limit information to the QR code and giving the QR code near a gate when giving the QR code to an authentic user.

### Solution to Problem

In order to solve the above problem, for example, configurations described in the claims are adopted.

The present application includes a plurality of means for solving the above problem. As an example, the entry/exit management system of the present invention is an entry/exit management system in which an entering person terminal, a reception server, and an entry/exit management server are connected by a network line.

The entry/exit management system of the present invention includes an input/output unit that receives a request for issuing a two-dimensional code from the entering person terminal and sends the two-dimensional code to the entering person terminal, an employee determination unit that determines that the entering person terminal from which the request for issuing has been made is a terminal operated by an employee when there is the request for issuing the two-dimensional code from the entering person terminal, and a database inquiry unit that makes an inquiry as to whether the employee who has made the request for issuing the two-dimensional code from the entering person terminal is registered in an employee database.

Furthermore, the entry/exit management system of the present invention includes: a right-to-enter determination unit that determines whether the employee who has made the request for issuing the two-dimensional code is an employee registered in the employee database and has a right to enter a facility in response to the inquiry from the database inquiry unit and; and a two-dimensional code generating/issuing unit that generates and issues a two-dimensional code containing time limit information with an expiration date for entry when the right-to-enter determination unit determines that the employee who has made the request for issuing the two-dimensional code from the entering person terminal has the right to enter.

Note that the request for issuing the two-dimensional code from the entering person terminal to the reception server is made when the employee enters a predetermined range of the facility to enter and the employee does not have a valid two-dimensional code.

### Advantageous Effects of Invention

According to the entry/exit management system of the present invention, it is possible to maintain high security of entry/exit management to the facility by giving time limit information to the QR code and giving near an entrance gate when giving the QR code to an authentic entering person.

Problems, configurations, and effects other than the problem, configurations, and effects described above will be clarified by the following description of embodiments.

### BRIEF DESCRIPTION OF DRAWINGS

FIG. 1 is a schematic diagram illustrating an area layout of an entry/exit management system according to an exemplary embodiment of the present invention.

FIG. 2 is a block diagram illustrating an overall configuration and functions of a reception server of the entry/exit management system according to the exemplary embodiment of the present invention.

FIG. 3 is a block diagram illustrating a configuration and functions of an entry/exit management server of the entry/exit management system according to the exemplary embodiment of the present invention.

FIG. 4 is a diagram illustrating a hardware configuration of the reception server and the entry/exit management server used in the entry/exit management system according to the exemplary embodiment of the present invention.

FIG. 5 is a sequence diagram for issuing a QR code to an employee in the entry/exit management system according to the exemplary embodiment of the present invention.

FIG. 6 is a diagram illustrating a data structure (table) of an employee database.

FIG. 7 is a diagram illustrating a data structure (table) of a visitor database.

FIG. 8 is a display screen of an entering person terminal when a QR code is sent.

FIG. 9 is a sequence diagram illustrating a procedure for issuing a QR code in consideration of when an entering person comes near a facility to enter and validity of a QR code held by the entering person.

FIG. 10 is a sequence diagram for issuing a QR code to a visitor in the entry/exit management system according to the exemplary embodiment of the present invention.

### DESCRIPTION OF EMBODIMENTS

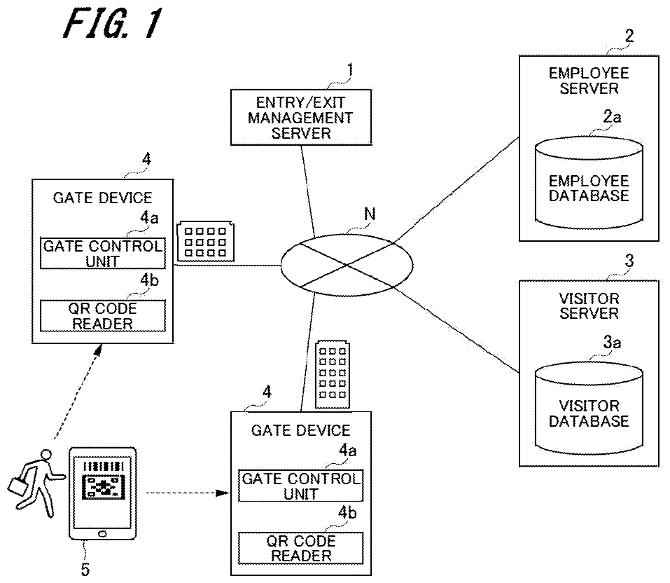

Hereinafter, exemplary embodiments (hereinafter, each referred to as “the present example”) related to an entry/exit management system and an entry/exit management method of the present invention will be described in detail with reference to FIGS. 1 to 10.

### Overall Configuration of Entry/Exit Management System

FIG. 1 is a schematic diagram illustrating an area layout of an entry/exit management system of the present example.

As illustrated in FIG. 1, the entry/exit management system of the present example is configured so that an entry/exit management server 1, an employee server 2, a visitor server 3, and a gate device 4 are connected to a network line N such as the Internet.

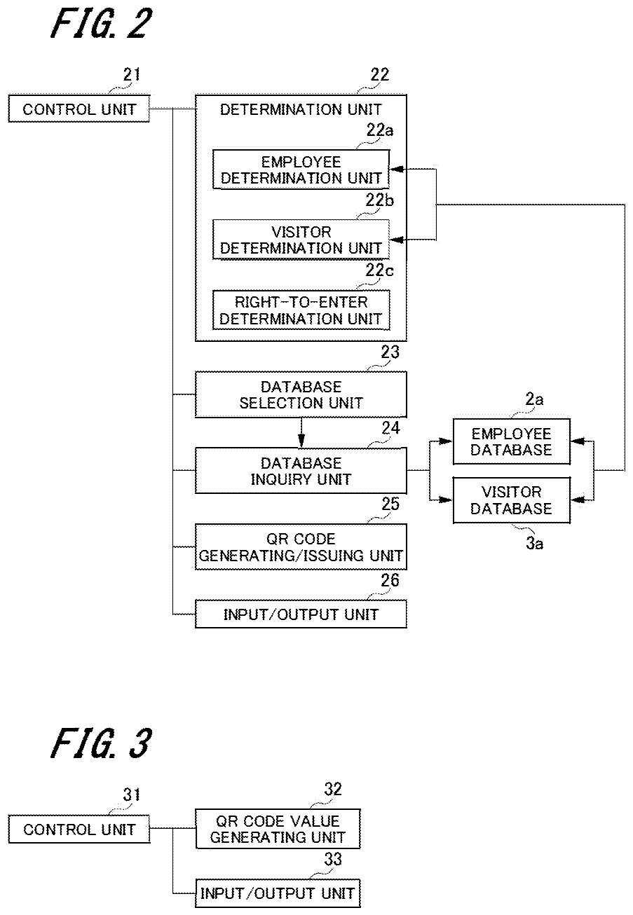

The employee server 2 has an employee database 2a, and the visitor server 3 has a visitor database 3a. Note that in FIG. 1, the employee server 2 and the visitor server 3 are illustrated as different servers, but the employee server 2 and the visitor server 3 may be configured as one server. In FIG. 2 to be described later, the employee server 2 and the visitor server 3 are described as an integrated “reception server”.

The gate device 4 includes a gate control unit 4a that controls opening and closing of a gate and a QR code reader 4b that reads a QR code. Note that the QR code is a registered trademark of DENSO WAVE INCORPORATED and refers to a two-dimensional code in a matrix format. In the present description or the drawings, the term “QR code” is used as a representative of two-dimensional codes.

In other words, when an entering person such as an employee or a visitor holds a QR code with an entering person terminal 5, the QR code reader 4b reads the QR code and sends the QR code to the gate control unit 4a. In response to this, the gate control unit 4a unlocks the gate to allow the entering person to pass.

The entering person terminal 5 is a terminal such as a smartphone or a tablet held by the employee or the visitor. As will be described later, the QR code is sent to the entering person terminal 5 from the reception server in which the employee server 2 and the visitor server 3 are integrated, and the entering person enters by holding the entering person terminal 5 over the gate device 4.

### Functions of Reception Server

FIG. 2 is a functional block diagram of the “reception server” in which the employee server 2 and the visitor server 3 are integrated. The reception server includes a control unit 21, a determination unit 22, a database selection unit 23, a database inquiry unit 24, a QR code generating/issuing unit 25, an input/output unit 26, an employee database 2a, and a visitor database 3a. Note that the QR code generating/issuing unit 25 is described as a “two-dimensional code generating/issuing unit” of a superordinate concept in the claims.

The determination unit 22 includes an employee determination unit 22a, a visitor determination unit 22b, and a right-to-enter determination unit 22c. The employee determination unit 22a determines whether an entering person who has applied for an issuance of a QR code from the gate device 4 is an employee registered in the employee database 2a.

The visitor determination unit 22b similarly determines whether the entering person who has applied for the issuance of the QR code from the gate device 4 is a visitor registered in the visitor database 3a.

Before issuing a QR code for entry to an entering person who desires to enter a facility (building), the right-to-enter determination unit 22c determines whether the entering person who has made a request for issuing a QR code for entry has a right to enter the facility.

The database selection unit 23 selects either the employee database 2a or the visitor database 3a to which an inquiry is to be made in order to confirm the registration of the entering person who has made the request for issuing the QR code from gate device 4.

The database inquiry unit 24 makes an inquiry for information on the entering person who has made the request for issuing the QR code in the gate device 4 illustrated in FIG. 1 to the employee database 2a or the visitor database 3a selected by the database selection unit 23.

In addition, in a case where there is the request for issuing the QR code from the entering person or the visitor who is an employee, the database inquiry unit 24 makes a request for a QR code value necessary for generating a QR code to the entry/exit management server 1. Note that an expiration date of an issued QR code is added to a QR code value provided from the entry/exit management server 1.

As illustrated in FIG. 2, in a case where the database selection unit 23 selects the employee database 2a, the database inquiry unit 24 searches the employee database 2a and sends a result of the search to the employee determination unit 22a. Then, the employee determination unit 22a determines whether the inquired employee is a registered employee. Then, in a case where the employee determination unit 22a determines that the inquired employee is a registered employee, the control unit 21 instructs the QR code generating/issuing unit 25 to generate a QR code and send the QR code to the entering person terminal (employee terminal) 5.

Meanwhile, in a case where the employee determination unit 22a determines that the inquired employee is not registered, the control unit 21 instructs the QR code generating/issuing unit 25 to send an error code to the entering person terminal (employee terminal) 5.

Similarly, in a case where the database selection unit 23 selects the visitor database 3a, the database inquiry unit 24 searches the visitor database 3a and sends a result of the search to the visitor determination unit 22b. Then, the visitor determination unit 22b determines whether the inquired visitor is a registered visitor. Then, in a case where the visitor determination unit 22b determines that the inquired visitor is a registered visitor, the control unit 21 instructs the QR code generating/issuing unit 25 to generate a QR code and send the QR code to the entering person terminal (visitor terminal) 5.

Meanwhile, in a case where the visitor determination unit 22b determines that the inquired visitor is not registered, the control unit 21 instructs the QR code generating/issuing unit 25 to send an error code to the entering person terminal (visitor terminal) 5.

The Input/output unit 26 receives the request for issuing the QR code from the gate device 4, and outputs a QR code generated by QR code generating/issuing unit 25 to the entering person terminal 5. In addition, the input/output unit 26 outputs an error code to an entering person to whom a QR code cannot be issued. Note that all the functions of the reception server illustrated in FIG. 2 can also be configured as functions in a cloud.

### Functions of Entry/Exit Management Server

FIG. 3 is a block diagram illustrating functions of the entry/exit management server 1 illustrated in FIG. 1. The entry/exit management server 1 includes a control unit 31, a QR code value generating unit 32, and an input/output unit 33.

The control unit 31 controls processing of each unit of the entry/exit management server 1. The QR code value generating unit 32 generates a value of a QR code containing time limit information requested from the reception server.

Here, the QR code value is a numerical value necessary for generating the QR code by the QR code generating/issuing unit 25 of the reception server. The input/output unit 33 receives a request for a value of a QR code containing time limit information from the reception server and sends a value of a QR code containing time limit information generated by the QR code value generating unit 32 to the reception server.

### Hardware Configuration of Reception Server and Access Entry/Exit Management Server

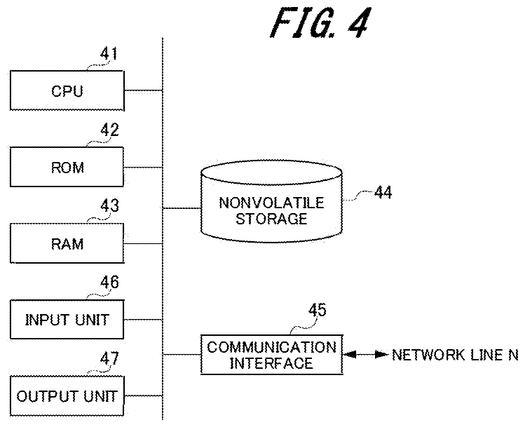

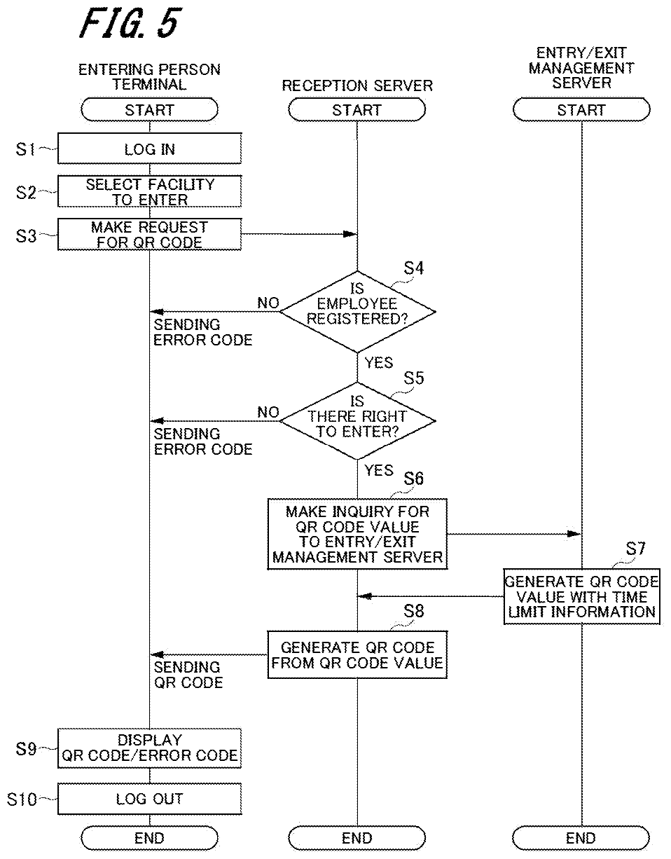

FIG. 4 is a diagram illustrating a hardware configuration of the reception server illustrated in FIG. 2 and the entry/exit management server illustrated in FIG. 3.

As illustrated in FIG. 4, a computer device constituting the reception server and the entry/exit management server in FIG. 2 includes a central processing unit (CPU) 41, a read only memory (ROM) 42, a random access memory (RAM) 43, and a nonvolatile storage 44 that are connected to a bus 40.

The CPU 41 reads a program code of software for implementing the functions of the reception server and the entry/exit management server from the ROM 42 and executes arithmetic processing. Variables and the like generated during arithmetic processing performed in the reception server and the entry/exit management server are temporarily written to the RAM 43. The CPU 41 implements the functions of the reception server illustrated in FIG. 2 and the entry/exit management server illustrated in FIG. 3 by executing the program code recorded in the ROM 42.

The nonvolatile storage 44 includes a nonvolatile memory such as a solid state drive (SSD). The nonvolatile storage 44 stores programs, data, and the like necessary for the operation of the CPU 41.

In addition, the reception server includes the input/output unit 26, and the entry/exit management server includes the input/output unit 33. The input unit 46 and the output unit 47 in FIG. 4 constitute the input/output units 26 and 33. In addition, the reception server and the entry/exit management server also include a communication interface (communication unit inter face (IF)) 45 for connection to the network line N. As the communication interface 45, for example, a network interface card (NIC) or the like is used.

### Procedure for Issuing QR Code for Employee

FIG. 5 is a sequence diagram of issuing a QR code for the employee in response to transmission/reception of data among the entering person terminal (employee terminal) 5 used by the employee, the reception server, and the entry/exit management server.

First, the employee logs in using the entering person terminal 5 (step S1) and selects the facility to enter (step S2).

Then, a request for a QR code is made from the entering person terminal 5 to the reception server (step S3).

In response to the request for the QR code from the entering person terminal 5, the employee determination unit 22a of the reception server determines whether the employee is registered in the employee database 2a (step S4).

When it is determined in step S4 that the employee who has made the request for the QR code is registered in the employee database 2a (YES in step S4), subsequently, the right-to-enter determination unit 22c of the reception server determines whether the employee who has made the request for the QR code has a right to enter (step S5).

When it is determined in step S5 that the employee who has made the request for the QR code has the right to enter (YES in step S5), the reception server makes an inquiry for a QR code value necessary for generating a QR code to the entry/exit management server 1 (step S6).

In response to the inquiry for the QR code value from the reception server, the entry/exit management server 1 generates a QR code value to which time limit information is added and sends the QR code value to the reception server (step S7). Then, the QR code generating/issuing unit 25 of the reception server generates a QR code on the basis of the QR code value sent from the entry/exit management server 1 and sends the QR code to the entering person terminal 5 (step S8).

In step S7, the time limit information is added to the QR code value in order to shorten a use period of the QR code to prevent fraud due to photographing by a camera or the like. In other words, since short-time limit information is added to the QR code used in the entry/exit management system of the present example, it is possible to shorten a period in which the QR code may be copied as much as possible.

Note that in a case where it is determined in step S4 that the employee who has made the request for the QR code is not registered (NO in step S4) and in a case where it is determined in step S5 that the employee who has made the request for the QR code does not have the right to enter (NO in step S5), the reception server sends an error code to the entering person terminal 5.

The entering person terminal 5 to which the QR code has been sent from the reception server in step S8 displays the QR code on a screen of the entering person terminal 5 (step S9). Note that in step S9, the entering person terminal 5 may display the error code sent in the case that determination in steps S4 and S5 is NO. Finally, the entering person terminal 5 logs out (step S10) and ends processing of sending the QR code to the employee.

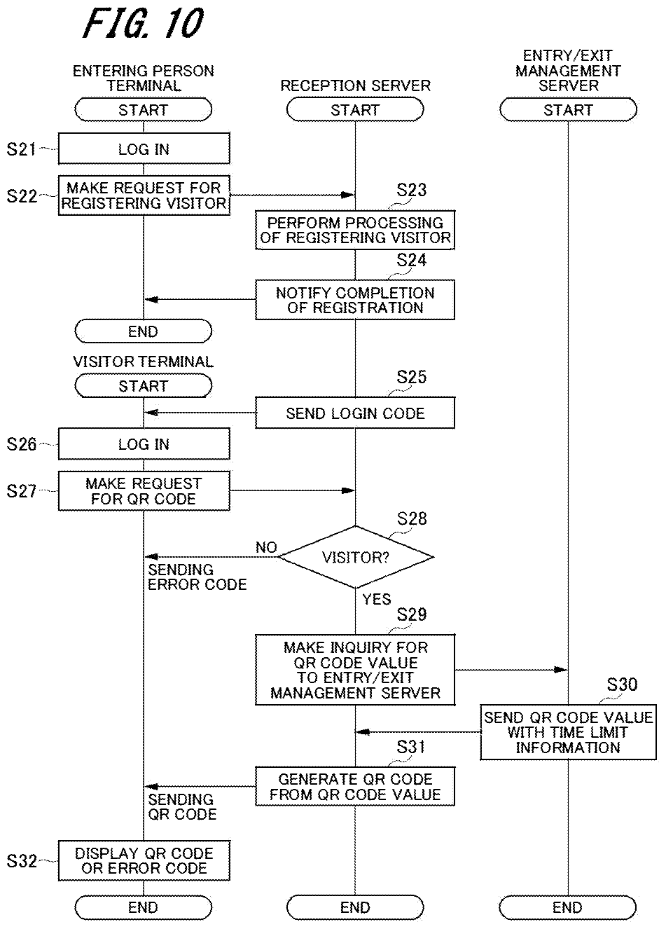

Although in FIG. 5, the entering person terminal 5 has been described as an employee terminal 5 used by an employee, if the entering person terminal 5 is a visitor terminal 5 used by a visitor instead of the employee, a procedure for issuing a QR code of FIG. 5 can also be applied as a procedure for issuing a QR code for the visitor. Note that a procedure for issuing a QR code for a visitor to be described later with reference to FIG. 10 describes a procedure for sending a QR code to a registered visitor after the visitor is registered in the visitor database 3a by an employee.

### Data Structure of Employee Database

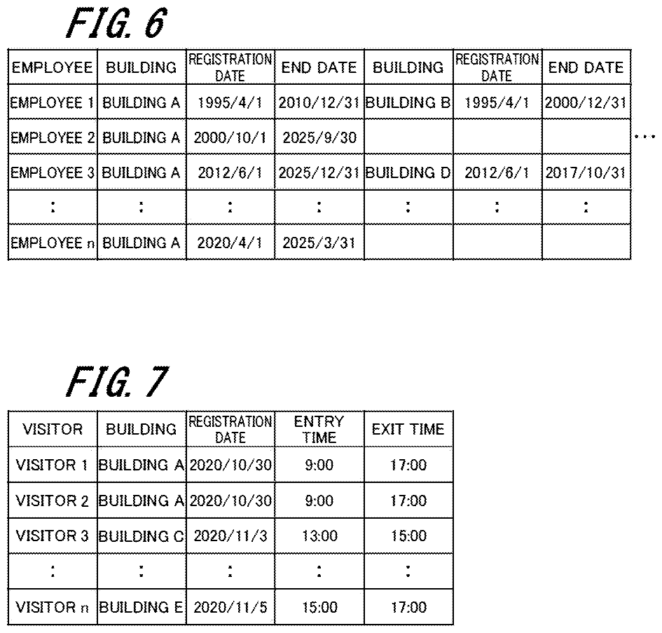

FIG. 6 is a table illustrating a data structure of the employee database 2a illustrated in FIG. 1. The employee database 2a has a field of an employee, a field of a building as a facility to enter, a field of a registration date, and a field of an end date.

As illustrated in FIG. 6, for an employee 1, entry to both a building A and a building B on Apr. 1, 1995 is registered, and it is registered that the entry to the building A ends on Dec. 31, 2010 and the entry to the building B ends on Dec. 31, 2000.

A term defined by a registered registration date and a registered end date in FIG. 6 may be considered as a period of a contract with a tenant company of a building or the like. For example, it is assumed that a tenant company moved into both the building A and the building B on Apr. 1, 1995. FIG. 6 illustrates that the tenant company is scheduled to leave the building A on Dec. 31, 2010 and is scheduled to leave the building B on Dec. 31, 2000.

In other words, it can be seen from FIG. 6 that an employee 1 of the tenant company has a right to enter both the building A and the building B until Dec. 31, 2000, but has no right to enter the building B in and after 2001 because the tenant company left.

In addition, for an employee 3, entry to both the building A and the building B was registered on Jun. 1, 2012, and it is registered that the entry into the building A ends on Jun. 1, 2025 and the entry into the building B ends on Oct. 31, 2017. For an employee 2 and an employee n, registration dates and end dates of only the building A are registered. The registration date and the end date may also be considered to correspond to a period of a contract in which a company to which each employee belongs occupies as a tenant.

### Data Structure of Visitor Database

FIG. 7 is a table illustrating a data structure of the visitor database 3a. In the visitor database 3a, it is registered that a visitor 1 and a visitor 2 are both scheduled to enter the building A at 9:00 on Oct. 30, 2020 that is a registration date and are scheduled to leave the building A at 17:00 on the same day.

In addition, for a visitor 3, an entry time of 13:00 and a scheduled exit time of 15:00 are registered in the visitor database 3a of the visitor server 3 on Nov. 3, 2020 on which the visitor 3 visited a building C.

### Display Screen of Entering Person Terminal 5

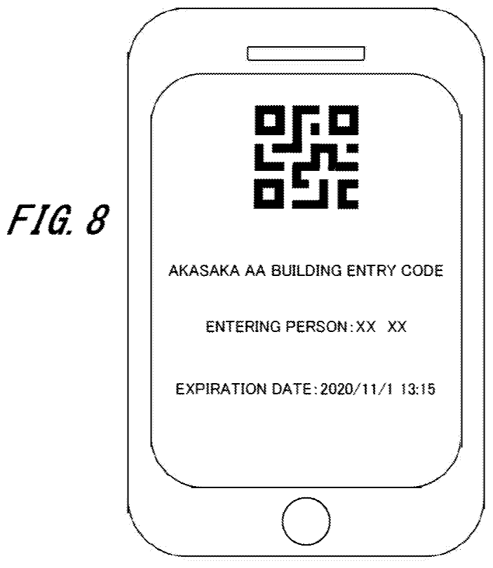

FIG. 8 is a display screen of the entering person terminal 5 (for example, a smartphone or the like) used by the employee or the visitor. The screen illustrated in FIG. 8 displays a QR code sent from the reception server. In addition, it can be seen from FIG. 8 that a person who can enter with this QR code is an entering person “xx xx”, and a building that the person can enter is “Akasaka AA building”. Furthermore, the screen of FIG. 8 indicates that an expiration date of this QR code is until 13:15 on Nov. 1, 2020.

Note that the display screen illustrated in FIG. 8 is merely an example, and a display field of the name of the entering person other than the QR code, a display field of the building that can be entered, and a display field of the expiration date are not limited to the display of FIG. 8.

### Procedure for Issuing QR Code When Coming Near Facility to Enter

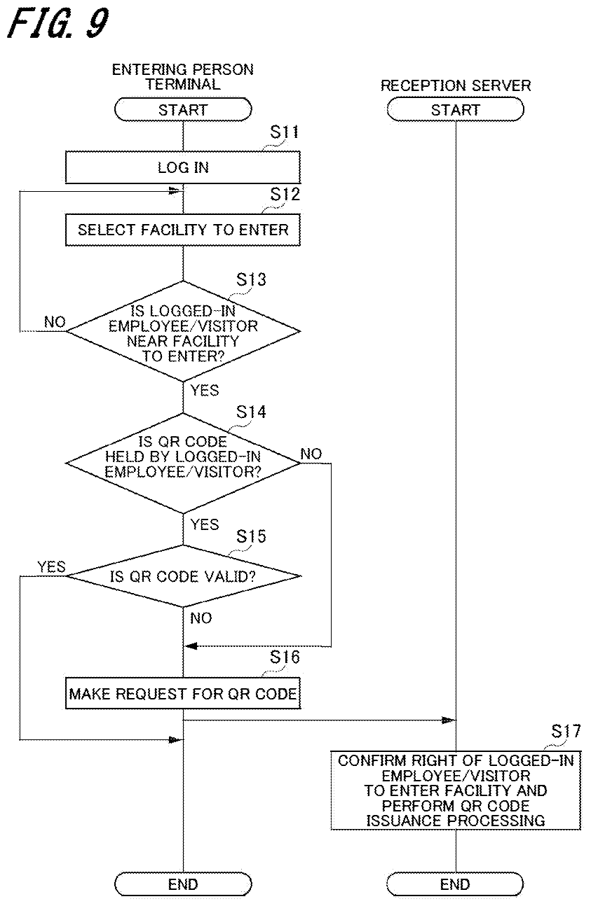

FIG. 9 is a flowchart illustrating QR code issuance processing when the entering person to the facility comes near the facility to enter. Here, the expression “near the facility” means that a distance from the facility is within a predetermined range. In FIG. 9, as a trigger for the QR code generating/issuing unit 25 of the reception server to issue a QR code, when the entering person enters a predetermined range of the building that is the facility to enter is set as near the facility.

As a result, an expiration date of the QR code to be issued can be further shortened. In other words, since the QR code is issued after the employee or the visitor approaches the facility to enter, for example, a validity period of the QR code can be set to about several hours. Therefore, it is possible to further shorten a period during which fraud such as copying of the QR code can be performed.

First, the employee or the visitor logs in using the entering person terminal 5 (step S11) and selects the facility to enter (step S12). Then, using a GPS function of the entering person terminal 5, the entering person terminal 5 determines whether the logged-in employee or visitor is near the selected facility to enter (step S13).

When it is determined that the logged-in employee or visitor is not near the facility to enter (NO in step S13), processing waits until the employee or visitor comes near the facility to enter. Then, in a case where it is determined that the logged-in employee or visitor is near the facility to enter (YES in step S13), next, the entering person terminal 5 determines whether the logged-in employee or visitor already hold a QR code for entering (step S14).

When it is determined in step S14 that the employee or the visitor already hold the QR code (YES in step S14), the entering person terminal 5 further determines whether a time limit of the QR code is valid (step S15). In other words, it is determined whether the expiration date of the QR code has not passed. Then, in a case where it is determined in step S15 that the expiration date of the QR code has passed (NO in step S15), the entering person terminal 5 makes a request for issuing a QR code to the reception server (step S16).

In step S15, in a case where the QR code held by the employee or the visitor is within the expiration date (YES in step S15), the processing ends without making the QR code issuance request in step S16.

In addition, in a case where it is determined in step S14 that the employee or the visitor does not hold the QR code (NO in step S14), the entering person terminal 5 makes the request for issuing the QR code in step S16 to the reception server.

In step S16, the reception server that has received the request for issuing the QR code from the entering person terminal 5 causes the determination unit 22 to determine the right to enter the facility of the employee or the visitor and performs QR code issuance processing for the employee or the visitor whose right to enter has been confirmed (step S17). Then, the QR code issuance processing when the employee or the visitor comes near the facility to enter ends.

### Procedure of Registering Visitor and Issuing QR Code for Visitor

FIG. 10 is a sequence diagram illustrating a procedure for issuing a QR code to a visitor after the visitor is registered by an employee in the entry/exit management system of the present example.

When a visitor needs to enter (enter) a facility (building), the visitor visits an employee of a tenant company having a room in the building in many cases. In such a case, the employee whom the visitor visits registers a date and time of the visit of the visitor in the visitor database 3a in advance. The procedure for issuing a QR code to a visitor illustrated in FIG. 10 is an example of a procedure in such a case.

First, the employee logs in to his/her entering person terminal 5 (step S21) and makes a request for registering the visitor to the reception server (step S22). When there is the request for registering the visitor from the employee, the reception server performs processing of registration in the visitor database 3a (step S23).

Then, the reception server notifies the employee terminal 5 that the registration of the visitor has been completed (step S24), so that the processing of registering the visitor by the employee ends.

Next, the reception server sends a login code to the entering person terminal (visitor terminal) 5 held by the visitor (step S25). The visitor receives the login code from the reception server, logs in (step S26), and makes a request for issuing a QR code to the reception server (step S27).

Then, the reception server determines whether the visitor who has made the request for issuing the QR code is a visitor (authentic visitor) registered by the employee (step S28). When it is determined in step S28 that the visitor who has made the request for issuing the QR code is not an authentic visitor (NO in step S28), the reception server sends an error code to the visitor terminal 5. In addition, in a case where it is determined in step S28 that the visitor who has made the request for issuing the QR code is an authentic visitor (YES in step S28), the reception server makes an inquiry for a QR code value necessary for generating the QR code to the entry/exit management server 1 (step S29).

In response to the inquiry from the reception server, the entry/exit management server 1 sends a QR code value to which the time limit information is added to the reception server (step S30). The reception server generates a QR code using the QR code value sent from the entry/exit management server 1 (step S31) and sends the QR code to the visitor terminal 5.

The visitor terminal 5 to which the QR code has been sent in step S31 displays the QR code on a screen of the visitor terminal 5 (step S32). Note that, in a case where an error code is sent from the reception server in the case that determination in step S28 is NO, the visitor terminal 5 displays the error code in step S32.

### Modifications

Note that the present invention is not limited to the above-described exemplary embodiments, and includes various modifications. In addition, the above-described embodiments has been described in order to describe the present invention in an easy-to-understand manner, and the present invention is not necessarily limited to ones including all the described configurations, and can be appropriately applied to other configurations.

For example, description has been given on a configuration in which in the entry/exit management system described as the exemplary embodiment of the present invention, a QR code is generated and issued in the reception server. However, the functions of the reception server illustrated in FIG. 2 are functions formed by computer programs, and these functions can be incorporated in the entry/exit management server 1 illustrated in FIG. 3 instead of the reception server.

In addition, since the entry/exit management server 1 and the reception server (the employee server 2 and the visitor server 3) are determined in relation to a tenant company that occupies a facility (building), the two servers are not necessarily required independently. It is also possible to construct all the functions of the entry/exit management server 1 and the reception server (the employee server 2 and the visitor server 3) as a computer system on a cloud. In this case, the entry/exit management server 1 and the reception server (the employee server 2 and the visitor server 3) are recognized as one function on the computer system.

Note that in the block diagrams illustrated in FIGS. 2 and 3, only control lines and information lines considered to be necessary for the description are illustrated, and not all the control lines and information lines on the product are necessarily illustrated. In practice, it may be considered that almost all the configurations are connected to each other. In addition, a display example of the entering person terminal 5 illustrated in FIG. 8 is an example, and it goes without saying that other display forms may be used as long as a QR code and other necessary information are displayed.

### REFERENCE SIGNS LIST

1 Entry/exit management server
2 Employee server
2a Employee database
3 Visitor server
3a Visitor database
4 Gate device
5 Entering person terminal (employee terminal, visitor terminal)
N Network line
21, 31 Control unit
22 Determination unit
22a Employee determination unit
22b Visitor determination unit
22c Right-to-enter determination unit
23 Database selection unit
24 Database inquiry unit
25 QR code generating/issuing unit
26, 33 Input/output unit
32 QR code value generating unit

1. An entry/exit management system in which an entering person terminal, a reception server, and an entry/exit management server are connected by a network line, the entry/exit management system comprising:
an input/output unit that receives a request for issuing a two-dimensional code from the entering person terminal and sends a two-dimensional code to the entering person terminal;
an employee determination unit that determines, when there is the request for issuing the two-dimensional code from the entering person terminal, that the entering person terminal from which the request for issuing has been made is a terminal scanned by an employee;
a database inquiry unit that makes an inquiry as to whether the employee who has made the request for issuing the two-dimensional code from the entering person terminal is registered in an employee database;
a right-to-enter determination unit that determines, in response to the inquiry from the database inquiry unit, whether the employee who has made the request for issuing the two-dimensional code is an employee registered in the employee database and has a right to enter a facility; and
a two-dimensional code generating/issuing unit that generates and issues a two-dimensional code containing time limit information with an expiration date for entry when the right-to-enter determination unit determines that the employee who has made the request for issuing the two-dimensional code from the entering person terminal has the right to enter, wherein
the request for issuing the two-dimensional code from the entering person terminal to the reception server is made when the employee enters a predetermined range of the facility to enter and the employee does not have a valid two-dimensional code.

2. The entry/exit management system according to claim 1, further comprising:
a visitor determination unit that determines, when there is a request for issuing a two-dimensional code from the entering person terminal, that a person who has made the request for issuing is a visitor, wherein
when there is the request for issuing the two-dimensional code from the entering person terminal, the request for issuing the two-dimensional code being made when the visitor enters a predetermined range of the facility to enter and the visitor does not have a valid two-dimensional code, the database inquiry unit makes an inquiry to a visitor database as to whether the visitor who has made the request for issuing the two-dimensional code is registered,
the right-to-enter determination unit determines whether the visitor who has made the request for issuing the two-dimensional code is a visitor registered in the visitor database and has a right to enter the facility, and
when it is determined that the visitor who made the request for issuing the two-dimensional code from the entering person terminal has the right to enter, the two-dimensional code generating/issuing unit generates and issues a two-dimensional code containing time limit information with an expiration date for entry.

3. The entry/exit management system according to claim 1, further comprising a database selection unit wherein
in a case where a database selected by the database selection unit is the employee database, the database inquiry unit makes an inquiry to the employee database, and in a case where the database selected by the database selection unit is a visitor database, the database inquiry unit makes an inquiry to the visitor database.

4. The entry/exit management system according to claim 3, wherein
the two-dimensional code containing time limit information with an expiration date for entry, the two-dimensional cod being generated by the two-dimensional code generating/issuing unit, is generated on the basis of a two-dimensional code value generated by the entry/exit management server.

5. The entry/exit management system according to claim 3, wherein
in a case where the right-to-enter determination unit determines that the employee or the visitor who has made the request for issuing the two-dimensional code does not have the right to enter the facility, the two-dimensional code generating/issuing unit sends an error code to the entering person terminal without sending a two-dimensional code.

6. The entry/exit management system according to claim 1, wherein
the request for issuing the two-dimensional code from the entering person terminal to the reception server is made after the entering person terminal selects the facility to enter.

7. The entry/exit management system according to claim 1, wherein
when there is a request for registering a visitor from the entering person terminal used by the employee, the reception server performs processing of registering the visitor, gives a registration completion notification to the entering person terminal used by the employee, and sends a login code to the entering person terminal used by the visitor.

8. The entry/exit management system according to claim 7, wherein
when there is a request for issuing a two-dimensional code from the entering person terminal used by the visitor who has received the login code to the reception server, the reception server determines that the entering person terminal used by the visitor who has made the request for issuing the two-dimensional code is an entering person terminal used by a registered visitor,
in a case where it is confirmed that the entering person terminal used by the visitor who has made the request for issuing the two-dimensional code is an entering person terminal used by a registered visitor, a two-dimensional code containing time limit information with an expiration date for entry is issued, and
in a case where it is not confirmed that the entering person terminal used by the visitor who has made the request for issuing the two-dimensional code is an entering person terminal used by a registered visitor, an error code is sent without sending the two-dimensional code.

9. An entry/exit management method implemented using an entry/exit management system in which an entering person terminal, a reception server, and an entry/exit management server are connected by a network line, the entry/exit management method comprising:
receiving, from an input/output unit, a request for issuing a two-dimensional code from the entering person terminal to the reception server, the request for issuing the two-dimensional code being made when an employee enters a predetermined range of a facility to enter and the employee does not have a valid two-dimensional code;
when there is the request for issuing the two-dimensional code from the entering person terminal, determining, by an employee determination unit, that a person who made the request for issuing is an employee;
making an inquiry, by a database inquiry unit, to an employee database as to whether the employee who has made the request for issuing the two-dimensional code from the entering person terminal is registered in the employee database;
in response to the inquiry from the database inquiry unit, determining, by a right-to-enter determination unit, whether the employee who has made the request for issuing the two-dimensional code is an employee registered in the employee database and has a right to enter the facility;
when the right-to-enter determination unit determines that the employee who has made the request for issuing the two-dimensional code from the entering person terminal has the right to enter, generating and issuing, by a two-dimensional code generating/issuing unit, a two-dimensional code containing time limit information with an expiration date for entry; and
sending, by the input/output unit, the two-dimensional code containing time limit information with the expiration date for entry to the entering person terminal.

10. The entry/exit management method according to claim 9, the entry/exit management method further comprising:
receiving, by the input/output unit, a request for issuing a two-dimensional code from the entering person terminal to the reception server, the request for issuing the two-dimensional code being made when a visitor enters a predetermined range of the facility to enter and the visitor does not have a valid two-dimensional code;
when there is the request for issuing the two-dimensional code from the entering person terminal, determining, by a visitor determination unit, that a person who made the request for issuing is a visitor;
making an inquiry, by the database inquiry unit, to a visitor database as to whether the visitor who has made the request for issuing the two-dimensional code from the entering person terminal is registered in a visitor database;
in response to the inquiry from the database inquiry unit, determining, by the right-to-enter determination unit, whether the visitor who has made the request for issuing the two-dimensional code is a visitor registered in the visitor database and has a right to enter the facility;
when the right-to-enter determination unit determines that the visitor who has made the request for issuing the two-dimensional code from the entering person terminal has the right to enter, generating and issuing, by the two-dimensional code generating/issuing unit, a two-dimensional code containing time limit information with an expiration date for entry; and
sending, by the input/output unit, the two-dimensional code containing time limit information with the expiration date for entry to the entering person terminal.
